(19) United States
(12) Patent Application Publication
(10) Pub. No.: US 2026/0251523 A1
(43) Pub. Date: Aug. 27, 2026

(54) LEAK-DETECTING DEVICE AND LEAK-DETECTING METHOD FOR DETECTING A GAS LEAK IN A TEST OBJECT

(71) Applicant: INFICON GMBH, Köln (DE)

(72) Inventors: Daniel WETZIG, Köln (DE); Silvio DECKER, Köln (DE)

(73) Assignee: INFICON GMBH, Köln (DE)

(21) Appl. No.: 18/861,710

(22) PCT Filed: Apr. 17, 2023
(86) PCT No.: PCT/EP2023/059896

§ 371 Date: Oct. 30, 2024

(30) Foreign Application Priority Data
May 10, 2022 (DE) 10 2022 111 596.8

(51) Int. Cl. G01M 3/26

(52) U.S. Cl. CPC G01M 3/26

(57) ABSTRACT

A leak detection device detects a gas leak in a test specimen. The leak detection device includes a port for receiving the test specimen or is connected to a test chamber holding the test specimen, a gas conduction path defined between the port and a valve for selectively closing the gas conduction path, a compressor pump arranged in the gas conduction path, and a compression volume. The compressor pump has an inlet and an outlet. The inlet is connected to the port. The compression volume is arranged in the gas conduction path between the outlet of the compressor pump and the valve so that the compressor pump compresses gas from the port into the compression volume when the valve is closed. The compression volume is connected to a gas pressure sensor for measuring the pressure inside the compression volume.

### CROSS-REFERENCE TO RELATED APPLICATIONS

The present application is a national stage application filed under 35 U.S.C. § 371 of PCT Application No. PCT/EP2023/059896, filed on Apr. 17, 2023, which claims priority to German patent application 10 2022 111 596.8, filed on May 10, 2022, the entire contents of all of which are incorporated by reference herein.

### BACKGROUND OF THE DISCLOSURE

### 1. Field of the Disclosure

The disclosure relates to a leak detection device and a leak detection method for detecting a gas leak in a test specimen.

### 2. Description of Related Art

In integral leak detection, it is tested whether gas escapes from a test specimen without localizing the gas leak. On the one hand, the test specimen can then be contained in a test chamber connected to a gas detector, wherein the test specimen is pressurized with a test gas while the test chamber is evacuated or the pressure inside the test chamber is at least lower than inside the test specimen. Alternatively, the test specimen contained in a test chamber or test envelope can be connected to the gas detector and evacuated while the test chamber or test envelope is or will be pressurized with a test gas, e.g. with room air. With integral leak detection, only the presence of a leak can be determined without localizing a leak.

Conventionally, an integral leak test is often carried out with the aid of a mass spectrometer, wherein the test chamber is evacuated with a pre-vacuum pump and/or a turbomolecular pump, and the test gas content in the analyzed gas mixture is measured with the mass spectrometer in a vacuum. Measuring the test gas content is also referred to as partial pressure measurement. The test gas content is a measure of the leak rate of a leak in the test specimen. In principle, it is possible to measure a rise in the test gas partial pressure and use this as an indication of a leak. If the rise or rate of rise (partial pressure rise per unit time) of the measured test gas exceeds a certain threshold value, this serves as an indication of a leak. Alternatively, it would also be conceivable to detect and assess a drop in the test gas content, for example, the test gas content inside the test specimen.

The accumulation principle measures the total pressure rise during a given period, i.e., the rise or rate of rise (total pressure rise per unit time) of the absolute pressure inside the measuring volume, i.e., inside the test chamber containing the pressurized test specimen. In doing so, the test chamber is closed. Alternatively, it is also conceivable here to detect a drop in the total pressure as an indication of a leak, for example, by observing the pressure in the pressurized test specimen. As soon as the pressure change, i.e. the rise or drop in total pressure, exceeds a certain threshold value, this is used as an indication of a leak.

### SUMMARY OF THE DISCLOSURE

The object of the disclosure is to provide an improved leak detection device and an improved method for detecting a gas leak in a test specimen.

According to the disclosure, a gas conduction path is provided with a port for the test specimen or a test chamber receiving the test specimen. The gas conduction path is provided with a valve for closing a downstream part of the gas conduction path, i.e. the part of the gas conduction path remote from the port. The direction of flow of the gas is considered to be the direction from the port towards the valve. In this respect, the port is located upstream of the valve, and the valve is located downstream of the port along the gas conduction path. Between the valve and the port, the gas conduction path is provided with a compressor pump, wherein a compression volume is formed between the compressor pump and the valve so that the inlet of the compressor pump is connected to the port and the outlet of the compressor pump is connected to the compression volume. As a result, the gas flows from the port along the gas conduction path through the compressor pump into the compression volume. In the closed state, the valve prevents gas from continuing to flow from the compression volumes downstream of the gas conduction path in the downstream direction. Thus, the compressor pump compresses gas flowing from the test specimen or the test chamber through the port into the gas conduction path into the compression volume so that the gas pressure inside the compression volume is greater than at the port or than in the gas conduction path upstream of the compressor pump. The compression volume is formed separately from the gas conduction path and is fluidically connected to the gas conduction path. Typically, the compression volume is connected to the outlet of the compressor pump via an inlet and connected to the valve via an outlet.

During an accumulation phase, the gas flowing in through the port is then compressed into the compression volume by the compressor pump. Thus, the change in gas pressure, i.e., the gas pressure rise, is increased by a factor resulting from the ratio of the compression volume to the test specimen volume or the test chamber volume. Compared to the conventional measurement of the pressure rise in the test specimen volume, this results in an increased pressure rise, in particular, if the compression volume is smaller than the test specimen volume or the volume in the test chamber connected to the port, respectively.

In the compression volume, as an alternative to measuring a temporal change in the total pressure, a temporal change in the partial pressure characteristic of the leakage gas can also be measured. If a specific test gas is used for leak detection, with which the test specimen is pressurized, for example, the proportion of the test gas in the gas mixture under examination can be detected as the partial pressure. If possible, the test gas should be different from those gas components that desorb from or out of the inner walls of the test chamber or the test specimen, such as water vapor in particular.

It is of particular advantage if the temperature of the compression volume is stabilized, for example, using a heating device that heats the compression volume, a cooling device that cools the compression volume, and/or an insulating device that thermally insulates the compression volume from its environment. In doing so, only the compression volume should be thermally stabilized.

If possible, the compression volume should be larger than that of the pipeline of the gas conduction path. This means that a section of the gas conduction path or the pipeline of the gas conduction path, respectively, which has a same length as the compression volume, has a smaller cross-section than the compression volume. The compression volume is then greater than the volume inside a section of the gas conduction path of the same length. Moreover, the compression volume should be smaller than the volume inside the test chamber of the test specimen.

The compressor pump can be a vacuum pump, which is not necessarily a turbo-molecular pump. For example, the compressor pump can be a diaphragm pump, a roots pump, or a turbomolecular pump.

It is advantageous if a selective measurement of the test gas components is carried out, for example, by using an absorber material or a getter in the area between the port and the compression volume along the gas conduction path in order to separate the test gas components to be detected from those of possible other gas components. If possible, at least one gas component other than the test gas component should be prevented from entering the compression volume. Alternatively, this gas component can be selectively bound/adsorbed in the compression volume.

It is of particular importance that a gas pressure sensor is connected to the compression volume so that the gas pressure sensor measures pressure inside the compression volume. With the aid of the gas pressure sensor, the change in pressure in the compression volume over time is determined and then evaluated for leakage assessment.

The gas pressure sensor can be a pressure gauge for measuring the total pressure rise inside the test chamber or inside the test specimen according to the pressure rise method. Alternatively or additionally, the gas pressure sensor can be designed as a gas-selective partial pressure sensor for measuring the partial pressure rise of the test gas. The partial pressure is defined as the relative proportion of the test gas in the gas mixture under examination. The measurement of the partial pressure rise can be performed according to the accumulation method, in which the partial pressure rise of the gas accumulating in the measuring range is measured with the vacuum pump shut off.

In particular, the gas pressure sensor can be a mass spectrometer, a membrane window sensor, an absorption spectroscopic sensor, e.g., an infrared absorption sensor, an emission spectroscopic sensor, e.g., an OES sensor, or semiconductor gas sensor, chemical gas sensor, or optical gas detector. In particular, the gas pressure sensor is not necessarily a pressure gauge. In the case of the total pressure rise method, the gas pressure sensor measures the rise in the total pressure of a gas mixture containing the test gas. In the case of the partial pressure rise, the gas pressure sensor measures the rise in the partial pressure portion of at least the test gas.

The optical spectral analysis carried out in an exemplary embodiment of the gas pressure sensor enables a particularly fast evaluation according to the pressure rise method or the accumulation principle of the total pressure and/or the partial pressure.

### BRIEF DESCRIPTION OF THE DRAWINGS

In the following, two exemplary embodiments of the disclosure are explained in more detail with reference to the Figures. In the drawings:

FIG. 1 is a schematic view of a first exemplary embodiment.

FIG. 2 is a schematic view of a second exemplary embodiment.

### DETAILED DESCRIPTION OF THE DISCLOSURE

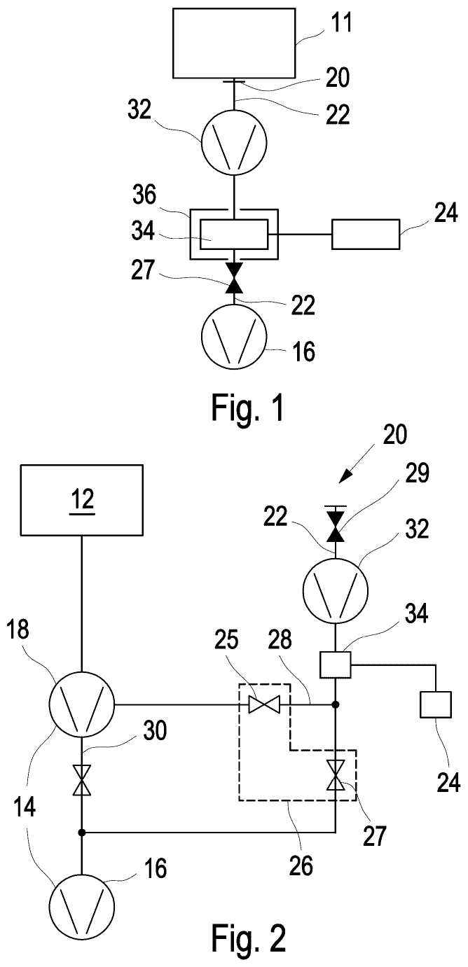

FIG. 1 shows an element 11 which can be a test specimen connected to a port 20 and surrounded by air or other test gas. Port 20 opens into a gas conduction path 22 that comprises, in the downstream direction from port 20, a compressor pump 32, a compression volume 34, a valve 27, and a vacuum pump 16. First, test specimen is evacuated by vacuum pump 16 with valve 27 open. During evacuation, compressor pump 32 can already be used for support. As soon as the pressure in test specimen falls below a threshold value, valve 27 is closed. The compressor pump 32 compresses gas coming from the test specimen into compression volume 34. In this process, the test specimen can have a negative pressure against its external environment, so that gas from the external environment of the test specimen enters the interior of the test specimen through a leak in the test specimen and is removed from the test specimen via port 20 and is compressed by compressor pump 32 into compression volume 34. In doing so, valve 27 is closed.

Alternatively, the element 11 can be in the form of a conventional vacuum chamber containing a test specimen pressurized with test gas. The internal pressure of the test specimen is then greater than the internal pressure in test chamber 11 so that test gas from the test specimen enters test chamber 11 through a leak and is compressed from there into compression volume 34 by compressor pump 32 via port 20 when valve 27 is closed.

A second valve 29, not shown in FIG. 1, provided in the exemplary embodiment shown in FIG. 2, can be provided in gas conduction path 22 between compressor pump 32 and port 20, or alternatively also between compression volume 34 and compressor pump 32. With the aid of valve 29, compressor pump 32 can be separated from port 20 when the test specimen or the test chamber is changed. Valves 25, 27 and 29 can be used to close off the compression volume.

A gas pressure sensor 24 is connected to the compression volume and measures the gas pressure inside the compression volume. Gas pressure sensor 24 can be a total pressure sensor or a sensor for integral measurement of the partial pressure rise of the test gas according to the accumulation principle inside compression volume 34. Gas pressure sensor 24 can be an optical sensor.

Gas pressure sensor 24 can be a total pressure sensor and/or a gas-selective partial pressure sensor 24, e.g., in the form of an optical emission spectroscopy sensor (OES). Valve 27 can be a single valve or a multi-part shut-off device that has additional valves, like shut-off device 26 in FIG. 2, or can be designed as a shut-off device and can separate compression volume 34 from the vacuum system.

A temperature stabilizing device 36 surrounds compression volume 34 in the form of an insulating housing, which is provided with a cooling device for cooling and a heating device for heating the compression volume.

Compression volume 34 comprises a housing having an inlet and an outlet, the inlet and the outlet each being connected to a section of gas conduction path 22. The housing of compression volume 34 can have a larger cross-section than the pipeline of the gas conduction path 22, so that compression volume 34 is larger than a section of the pipeline of gas conduction path 22 of the same length. In addition, compression volume 34 is smaller than test specimen or test chamber 11 at port 20.

The same applies to the exemplary embodiment in FIG. 2. There, in addition to gas pressure sensor 24 for integral measurement according to the accumulation principle, a mass spectrometric gas detector 12 is provided, which is evacuated via a turbomolecular pump 18 and a vacuum pump 16 designed as a pre-pump. Turbo-molecular pump 18 and vacuum pump 16 form a vacuum pump system 14. The outlet of vacuum pump 16 is open to the atmosphere. At its end opposite port 20, gas conduction path 22 opens into a gas line 30 connecting vacuum pump 16 and turbomolecular pump 18. A further gas conduction path 28 connects an intermediate port of turbomolecular pump 18 with a section of gas conduction path 22 arranged between compression volume 34 and valve 27. Gas conduction path 28 comprises a further controllable valve 25. Controllable valve 27 and controllable valve 25 form a shut-off device 26 with which compression volume 34 can be shut off from vacuum pump system 14.

The basic principle of the disclosure is to measure the gas pressure in the integral leak detection according to the accumulation principle not inside the test chamber or in the test specimen, but in a separate compression volume 34, into which a compressor pump 32 arranged between the test specimen or test chamber 11 and the compression volume 34 compresses the gas from the test specimen or test chamber. This increases the gas pressure rise by a factor of the volume ratio between the compression volume and the volume inside the test specimen or test chamber, respectively. The smaller the volume of the compression volume and the more efficient or stronger compressor pump 32 compresses the gas, the stronger the pressure rise resulting in the compression volume.

In this case, instead of the temporal change in the total pressure, the temporal change in a partial pressure of the test gas can also be measured in compression volume 34 in order to enable a distinction to be made with respect to gas components that desorb from or out of the walls of the test chamber or the test specimen, such as water vapor in particular. Accumulation thus takes place in a significantly shorter time than in the case of accumulation inside the test chamber or inside the test specimen, so that leak detection according to the disclosure enables faster and more precise leak detection, which also reduces the influence of desorbing gas components.

1. A leak detection device for detecting a gas leak in a test specimen, the leak detection device comprising:
a port for receiving the test specimen or that is connected to a test chamber holding the test specimen,
a gas conduction path defined between the port and a valve for selectively closing the gas conduction path,
a compressor pump arranged in the gas conduction path,
wherein the compressor pump has an inlet connected to the port and an outlet; and
a compression volume arranged in the gas conduction path between the outlet of the compressor pump and the valve so that the compressor pump compresses gas from the port into the compression volume when the valve is closed,
wherein the compression volume is connected to a gas pressure sensor for measuring the pressure inside the compression volume.

2. The leak detection device according to claim 1, wherein the gas pressure sensor is configured for integral measurement of a total pressure change according to the pressure rise method or the pressure drop method and/or for measurement of a partial pressure change of at least one test gas according to the partial pressure rise method or the partial pressure drop method.

3. The leak detection device according to claim 1, wherein the compression volume is smaller than a volume of the test chamber or a volume of the test specimen.

4. The leak detection device according to claim 3, wherein the compression volume is at most half as large as the volume of the test chamber or the volume of the test specimen.

5. The leak detection device according to claim 1, wherein the compression volume has a larger cross-section in the longitudinal direction of the gas conduction path than the gas conduction path, so that the compression volume is larger than a volume in a section of the gas conduction path that is as long as the compression volume.

6. The leak detection device according to claim 1, wherein the compression volume has a temperature stabilizing device that is configured to stabilize the temperature inside the compression volume.

7. The leak detection device according to claim 6, wherein the temperature stabilizing device comprises a heating device heating the compression volume, a cooling device cooling the compression volume and/or an insulating device insulating the compression volume from its external environment.

8. The leak detection device according to claim 1, wherein the compressor pump is at least one selected from the group consisting of: a vacuum pump, a diaphragm pump, a roots pump, and a turbomolecular pump.

9. The leak detection device according to claim 1, wherein the gas conduction path is connected to a vacuum pump on a side of the valve opposite the compressor pump.

10. The leak detection device according to claim 1, wherein the compression volume comprises an absorber material or a getter as a filter to allow a test gas to be detected by the gas pressure sensor to block or bind gases other than the test gas.

11. The leak detection device according to claim 1, wherein the compressor pump or a further pump different from the compressor pump is gas-selective between the compression volume and the port so that a test gas to be detected by the gas pressure sensor is delivered into the compression volume and at least one gas different from the test gas is blocked or compressed less effectively.

12. A method for detecting a gas leak in a test specimen using a leak detection device according to claim 1, the method comprising the following steps:
delivering a gas from the test chamber or from a test specimen, with the compressor pump, from the port along the gas conduction path into the compression volume so that the gas in the compression volume has a higher pressure than a pressure in the test specimen or a pressure in the test chamber while the valve is closed;
measuring the gas pressure inside the compression volume;
determining a temporal change in the measured gas pressure inside the compression volume; and
evaluating whether the test specimen comprises a leak based on the determined change in the measured gas pressure.

13. The method according to claim 12, wherein the measured gas pressure is an absolute gas pressure in the form of a total pressure inside the compression volume or a partial pressure of a test gas component in a gas mixture contained in the compression volume, wherein the determined change in the gas pressure is a pressure rise.

14. The leak detection device according to claim 3, wherein the compression volume is at most one-tenth as large as the volume of the test chamber or the volume of the test specimen.

15. The leak detection device according to claim 3, wherein the compression volume is at most one hundredth as large as the volume of the test chamber or the volume of the test specimen.
